(19) United States
(12) Patent Application Publication
(10) Pub. No.: US 2026/0336195 A1
(43) Pub. Date: Oct. 29, 2026

(54) CONCENTRIC MOLD COOLING

(71) Applicant: SIDEL PARTICIPATIONS, Octeville-sur-Mer (FR)

(72) Inventor: Mikael DERRIEN, Octeville-sur-mer (FR)

(21) Appl. No.: 19/103,592

(22) PCT Filed: Aug. 9, 2023
(86) PCT No.: PCT/EP2023/072037

§ 371 Date: Feb. 13, 2025

(30) Foreign Application Priority Data
Aug. 19, 2022 (FR) FR2208392

(51) Int. Cl. B29C 49/48

(52) U.S. Cl. CPC B29C 49/4823; B29C 2049/4825

(57) ABSTRACT

Provided are methods and devices for molding a container from a preform. The device includes a base piece having a bottom centered on a central axis. The base includes a cavity against which the preform can be pressed to create a container base. The base piece includes an external periphery and a duct, the duct extending generally transverse to the central axis to circulate a fluid for controlling the temperature of the device. The duct has a first portion that includes a first inlet zone offset from the central axis for receiving the fluid and an arc separate from the central axis that causes the fluid to flow towards the central axis.

### TECHNICAL FIELD

The present invention relates to the field of blow-molding of containers made of plastic, notably of PET, polyethylene terephthalate, more particularly from a smaller parison, or preform, which, through the injection of pressurized gas, is made to expand inside a mold until it conforms to the shape of a hollow cavity provided inside the mold. The subject of the invention is a device and method for manufacturing a container using blow molding.

### PRIOR ART

In the field of blow-molding of containers in a mold, it is necessary to keep control of the temperature of said mold. This is because since the preforms are heated to allow them to be transformed, they transmit some of their heat energy to the blow-molding mold. If this heat is not removed from the mold, the latter will continue to heat up on each blow-molding cycle until it reaches a temperature that prevents production, particularly as a result of prohibitive production defects of the deformation type. It is therefore necessary to provide a circulation of cooling liquid within the mold, a heat exchanger generally being provided in order to re-release the heat energy from the mold that has been absorbed by the liquid.

The cooling circuits within the mold are generally hollowed out at least in the bottom of the mold.

Conventionally, the preform takes the form of a circular cylindrical tube having, at one end, an open portion with a neck, the other end being closed with the overall shape of a hemisphere. This hemispherical part is therefore stretched in order to contribute to forming the bottom of the bottle, by being pressed intimately against the molding cavity that the mold bottom exhibits at this point. Prior to the blowing step, the preform will have been manufactured by injection molding and, on the outside end of this hemisphere, it generally bears traces of the injection point.

U.S. Pat. No. 7,025,584 discloses the implementation of a conventional cooling process, namely the creation of a flow circuit in the bottom of the mold. More specifically, that patent proposes, for petaloid bottoms, therefore bottoms having projecting feet separated by recessed valleys, a circuit that more extensively follows the surface of the valleys, thanks to hollow segments that are elongated in the axial direction, and partitions carefully positioned in the middle of these longitudinal hollow segments.

Publication CN202037856 illustrates a serpentine coil in the form of the divergent spiral. The cooling liquid arrives in the base-piece of the mold from the peripheral surface of said base-piece, and leaves the base-piece likewise at this surface. The cooling liquid arrives in the cooling duct at the central part and moves out progressively as far as the periphery of the mold.

Finally, CN203381178 discloses a cooling duct obtained by providing walls in the form of mutually distant ribs.

Given the thickness and the stretching of the central region of the preform, and the important part it plays in the mechanical strength of the container subsequently obtained, the in-mold cooling of this region is particularly important.

The objective of the invention is to improve the cooling of the mold bottom and more particularly to improve the cooling of the base of the container obtained, in order to improve the mechanical strength of the container obtained and possibly increase production rates.

### DISCLOSURE OF THE INVENTION

The invention thus proposes a molding device, and a corresponding method, that better distributes the cooling of the base of the container. In order to do this, what is proposed is that the cooling should begin in a ring around the central axis of the mold, should continue in a manner that converges toward said center, and then, after this cooling of the central part, should continue with the part lying beyond said ring, preferably in a divergent manner, namely toward the periphery of the mold.

Adopting this approach, which avoids heating of the cooling liquid that would otherwise be caused by initial circulation close to the molding cavity and toward the central axis, ensures that the cooling achieved is maximized because it is obtained by the liquid at the start of its cycle beneath the molding cavity, in this ring region. The liquid therefore begins its cooling action by circulating some distance from the central axis, between the central axis and the periphery, around a complete or almost-complete ring, and then gradually moves closer toward the central axis and then, in a second phase, acts in the part lying between said ring and the periphery. The cooling power therefore decreases from a ring around the central axis as far as the center, and then from this ring as far as the periphery, along a duct, the path of which is shaped accordingly.

Thus, according to the invention, what is proposed is that, in the mold bottom, and through use of a suitable duct, the liquid be organized to circulate first of all from an intermediate region toward the center of the mold and then between the intermediate region and the periphery of the mold. Thus, the most intense cooling is achieved in an intermediate region around and some distance from the center of the mold, where the vertex, namely the injection point, of the preform normally lies.

Thus one subject of the present invention is a device for molding a container from a preform, said device comprising a base-piece and having a central axis, said base-piece having a bottom generally centered on the central axis and in which there is formed a molding cavity against which said preform can be pressed so as to create the base of said container, said bottom having an external periphery and comprising a duct which extends generally transversely to said central axis between the latter and the periphery and inside which may be circulated a fluid for controlling the temperature of said device.

The duct 10 extends generally transversely to the central axis 5 at a distance that is small enough that it has a significant thermal effect. In the case of a container bottom which is significantly non-flat, the duct 10 may at least partially follow the profile of the molding cavity 7 and therefore have parts that are slightly offset from one another along the central axis 5. Overall, the duct 10 extends within the bottom 6 between two planes perpendicular to the central axis 5 that allow the fluid circulating therein to perform its heat-regulating function. Conventionally, the plane furthest from the molding cavity 7 is distant therefrom by around five millimeters, while the plane closest to the molding cavity 7 is distant therefrom by around two millimeters.

According to the invention, the duct 10 has a first portion 11 which, on the one hand, has a first inlet region 12 offset from the central axis 5 to receive the fluid, and an arc distant from said central axis 5 which follows it and which, on the other hand, causes said fluid to flow, preferably after said arc, toward said central axis 5, so that the cooling effect is greater in a ring around the central axis 5 than at the central axis 5 itself. The first inlet region 12 is where the cooling liquid arrives in the region in which the cooling occurs, and is situated less than approximately four centimeters away from the central axis 5, preferably less than three centimeters away. The arc in which the fluid then circulates right at the start of its action extends over at least three-quarters of a revolution or even over an entire revolution, before the part of the duct 10 that brings the fluid closer to the central axis 5. This arc, which may be an arc of a circle or have a different profile, therefore provides a first cooling action in a ring around the central axis 5, or at least part of such a ring representing a significant angular extent, of the order of at least half a revolution, and preferably at least three-quarters of a revolution. It is not until after the fluid has circulated through this first part around and some distance from the central axis 5, and thus applied a first cooling effect to a perimeter around and distant from the central axis 5 that it is directed toward the central axis 5 by the duct 10. The first portion 11 in which the start of the cooling action by the cooling liquid occurs, therefore converges toward the central axis 5 after a first part which makes an entire revolution or at least three-quarters of a revolution some distance from the central axis 5.

According to one possible additional feature, the duct 10 has a second portion 13 located between the first portion 11 and the periphery 9, downstream of the first portion 11, so that the fluid flow is first of all in the first portion 11, and then in the second portion 13, thereby making it possible to achieve cooling of the base beyond the ring delimiting the first portion 11. As will be described further later on, the second portion 13 is situated after the first portion 11, in the direction of flow of the fluid. The second portion 13 therefore extends between the ring in which the first portion 11 is situated and the periphery 9 of the bottom 6, namely the external surface of the bottom, which is essentially cylindrical in shape.

The first portion 11 and the second portion 13 may be in the same plane perpendicular to the central axis 5 or slightly offset like if, for example, the base of the bottle is not flat.

According to another possible additional feature, the base-piece 4 comprises a distributor 14 arranged against the bottom 6 at the central axis 5 and provided within it with a passage 15 for said fluid, said passage 15 having an inlet opening 16 for receiving fluid leaving the first portion 11 and an outlet opening 17 for supplying the fluid to the second portion 13, notably at the second inlet region 19 of the second portion 13 thereby enabling the cooling fluid to be conveyed, using a simple construction, from the downstream end of the first portion 11 to the upstream end of the second portion 13, which is further away from the central axis 5. The distributor is thus housed in a housing provided for that purpose in the bottom 6 and/or the cover 20. More specifically, the first and second portion, in the form of a groove, between them create walls in the bottom 6. The cover comes into contact with part of these walls, another part of these walls coming into contact with the distributor on one of the faces thereof, its other face being held in the cover.

As will be described later on, this circulation away from the central axis 5 to beyond the ring at which the duct 10 performs the first part of the cooling, may take place in a plane that is farther from the molding cavity than the plane in which the first portion 11 of the duct 10 is situated.

The inlet opening 16 is therefore situated notably at the central axis 5, facing the first outlet zone that forms the outlet end of the first portion 11, the fluid passing from the first portion 11 into the distributor in a movement along the central axis 5, the outlet opening 17 being notably offset from the central axis 5 and distanced therefrom, facing the second inlet region 19 from where the fluid circulates in the second portion 13, the circulation of the fluid at the outlet opening 17 and at the second inlet region 19 being generally transverse to the central axis 5.

The base-piece 4 thus notably adopts the form of a stack obtained from, in succession, the cover 20, the distributor 14 and the bottom 6.

According to another possible additional feature, the distributor 14 has an axial orifice 18 extending at least partially along the central axis 5 and offset therefrom, said axial orifice 18 opening into the first inlet region 12 in order there to convey the fluid into the first portion 11, thereby enabling the cooling fluid to be conveyed to the start of the duct 10. This axial orifice 18 is close to the central axis 5, but slightly distanced therefrom, and ends at the ring which delimits an inner part that is cooled after the outer part.

According to another possible additional feature, the second portion 13, on the one hand, has a second inlet region 19 where it receives the fluid and, on the other hand, causes the fluid to flow away from the central axis 5 toward the periphery 9, thereby making it possible to cool that part of the molding cavity 7 that molds, for example, the feet of a petaloid bottom.

According to another possible additional feature, the base-piece 4 comprises a cover 20 in which there is formed a path 22 for conveying the fluid toward the duct 10, moving it at least partly in the direction of the central axis 5 from an inlet point 21, the duct 10 taking, for example, the form of a groove hollowed into the base-piece 4 and closed by the cover 20. The path 22 opens for example into the axial orifice 18 of the distributor 14. Where applicable, as shown in FIGS. 2 and 8, the cover 20 also comprises a discharge canal 23 which communicates, on the one hand, with the outlet of the duct 10 in order to receive fluid therefrom and, on the other hand, with the outside of the base-piece 4 so as to discharge the liquid from the molding device. The cover 20 has the overall shape of a cylinder of revolution.

According to another possible additional feature, the molding device 1 further comprises lateral shells that extend along the central axis 5 and against which the preform 3 can be pressed so as to create the sides of the container 2 during the blow-molding, thereby making it possible to form the final packaging. The device 1 thus comprises not only the base-piece 4 that will define the base of the container 2, but also at least one and preferably two lateral shells, which come to face one another during the blow-molding, to define the sides of the container 2.

Another subject of the invention is a method that implements the device described hereinabove. Thus, one subject of the invention is a method for manufacturing a plastic container 2 by blow-molding a preform 3, wherein the preform 3 is placed in a molding device 1 having a central axis 5 and comprising a base-piece 4 having a bottom 6, then a pressurized gas is injected into the preform 3 to cause it to conform to the interior contour of said molding device 1 until a container 2 is formed, the method further comprising keeping control of the temperature of the molding device 1 using a fluid.

According to the invention, the control over the temperature is achieved by circulating a fluid in the molding device 1 at the base-piece 4, this being along a path generally transverse to the central axis 5, beginning in a first phase in a ring around the central axis 5 some distance therefrom and from the exterior surface of the base-piece 4, the fluid then heading toward or away from the central axis 5.

This ring delimits a part which is to its inside, comprising the central axis 5, and a part which is to its outside, with the periphery 9. Cooling begins at this ring, then continues in the part to its inside, progressing toward the central axis 5, preferably without moving back away therefrom, and then continues from this ring but now toward the periphery 9, and therefore in the part to its outside, after a communication between the two parts which takes place in an offset plane, preferably further away from the molding cavity 9 than that in which the first portion 11 of the duct 10 for the inside part extends and than that in which the second portion 13 of the duct 10 for the outside part extends.

According to one possible feature of the method, the preform 3 has a vertex 24 and is placed in the molding device 1 in such a way that its vertex 24, after stretch-blow-molding, lies generally at the level of the central axis 5, such that the most powerful cooling, namely when the fluid is at the start of its circulation through the base-piece 4, is performed not at the vertex 24 of the preform 3, but at a ring or ring portion surrounding the vertex 24. In contrast with the usual cooling techniques, the cooling fluid is therefore not heated as it approaches the molding cavity 7 by advancing along the central axis 5 as far as the duct 10, cooling begins neither with the tip or vertex 24 of the preform, so not with the center of the container 2 in order to move progressively away therefrom, nor with the periphery 9 in order to move toward the central axis 5, but rather begins with a central ring before converging in any way toward the central axis 5. In the first portion 11, the fluid remains distant from the central axis 5 and then moves closer toward same, and does not move away from same.

According to one possible feature of the method, after the first phase of circulation of the fluid in the base-piece 4, the fluid circulates such that it moves closer toward the central axis 5. Thus, after the first phase during which the fluid acts on a ring distant from the central axis 5, this fluid is sent progressively to the central axis 5. The cooling effect is therefore the greatest, because this is the first effective heat-exchange region, at a ring, then toward the center, therefore toward central axis 5. This circulation in the first portion 11 beginning circumferentially and then becoming convergent takes place close to the molding cavity 7, namely in particular closer to the molding cavity than the communication between the first and second portions.

According to one possible feature of the method, the circulation of the fluid in the base-piece 4 comprises a phase subsequent to the first phase and during which the fluid circulates away from the central axis 5 from beyond the ring, notably as far as the periphery 9 of the base-piece 4. The fluid then circulates in the second portion 13 of the duct, from the second inlet region, and moves away from the central axis 5, generally in a direction perpendicular thereto. The second portion 13 of the duct 10 may adopt the form of a spiral through which fluid flows in a divergent direction, or simply of successive arcs of a circle connected by radial segments.

### BRIEF DESCRIPTION OF THE DRAWINGS

Further advantages and features will become better apparent from the following description, given by way of nonlimiting example, of a single embodiment variant of the device according to the invention, with reference to the attached drawings in which:

FIG. 1 is a view in cross section of the molding device, with the stack of the cover, of the distributor and of the base-piece

FIG. 2 illustrates the cover and the distributor housed therein

FIG. 3 is a cross section depicting the cover and the distributor

FIG. 4 shows the stack of the bottom, of the distributor and of the cover, in cross section on a plane offset from the main axis

FIG. 5 shows the duct as hollowed into the bottom of the base-piece, with two non-connected portions

FIG. 6 shows the duct as hollowed, with the distributor in its operating position

FIG. 7 shows the distributor within the cover, with notably the groove that allows the fluid to pass from the distributor to the second portion of the duct

FIG. 8 shows a cross section on a plane perpendicular to the main axis, at the site of the ribs that delimit the duct, with the distributor trapped between them and the cover

FIG. 9 shows a preform

FIG. 10 shows a container

FIG. 11 shows a spiral profile

FIG. 12 shows a spiral profile for the distributor

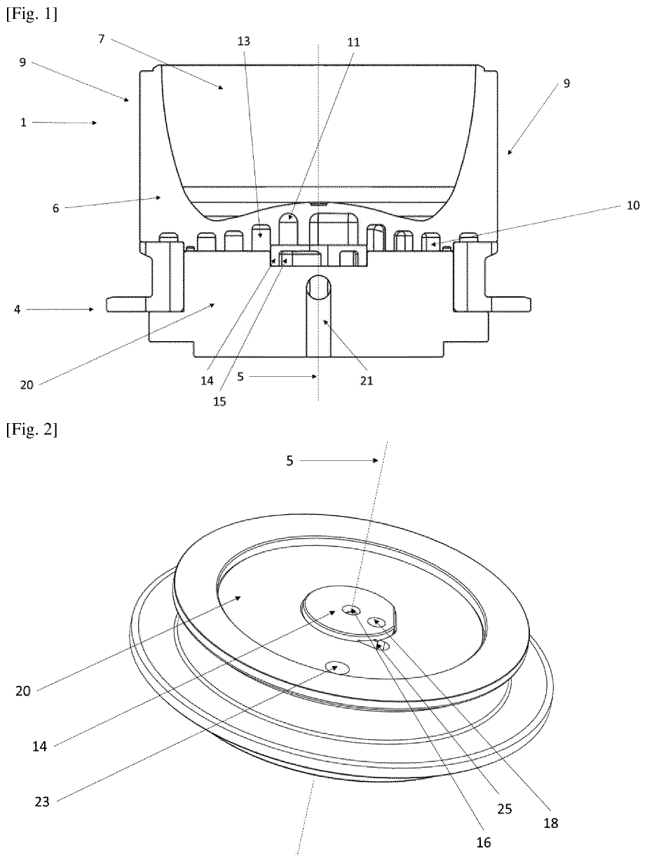

### EMBODIMENT OF THE INVENTION

The molding device 1 according to the invention is used to accept preforms 3 into which a pressurized fluid is injected in order to press them intimately against the molding cavity 7 that said molding device 1 exhibits. This molding device 1 comprises at least a base-piece 4, which serves to form what is normally the lower part of the future container 2, or in other words its bottom via which the container 2 will then stand vertically on a horizontal surface.

The molding device 1 may also comprise lateral shells which for their part will form the lateral surfaces of the container 2. The molding device 1 is therefore at least a mold bottom but may comprise other elements that make it into a full blow-molding mold.

Be that as it may, the molding device 1 has a central axis 5 which in fact corresponds to the axis along which the container 2 that it forms extends; furthermore, the preform 3 is aligned about this central axis 5 within the molding device 1. The molding device 1 has the general shape of a cylinder about this central axis 5 and with a length, as mentioned, that is obviously dependent on the other components that it may potentially comprise.

The molding device 1 therefore comprises a base-piece 4, in the continuation of which there may, as applicable, be shells.

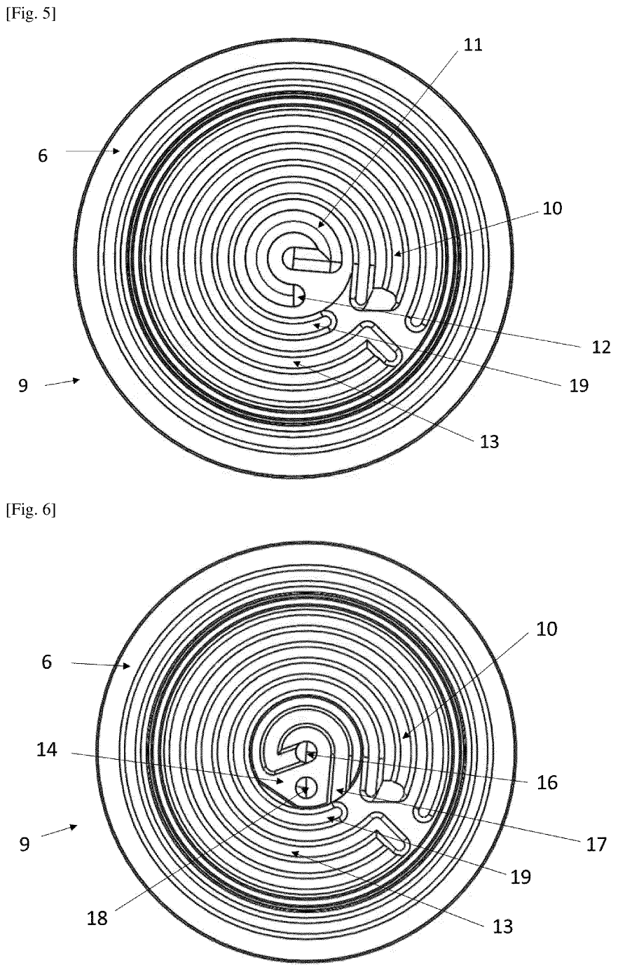

This base-piece 4 exhibits a stack of, along the central axis 5, a bottom 6 against which the preform 3 will lie and, against this bottom on the other side, a cover 20. The bottom 6 which, at its external periphery 9 has a perimeter that is generally a cylinder of revolution about the central axis 5, bears the molding-cavity surface 7 for creating the shape of the container 2. On the opposite side from the molding cavity 7, the bottom 6 has a duct 10, for example in the form of at least one groove. FIG. 5 shows this part of the bottom 6 with a duct 10 made up of two grooves, each one as a single piece. It is of course possible to conceive of more than two distinct grooves. The at least one groove, and therefore the duct 10, has a shape made up, on the one hand, of arcs of a circle which are centered on the central axis 5 and each have their own specific radius and, on the other hand, of straight portions perpendicular to the central axis 5 and allowing an arc of a first radius to be connected to an arc of a second radius. It is also possible to conceive of a duct 10 having at least one spiral, namely a profile in which the distance from the central axis 5 changes over a circumference less than or even greater than a complete revolution.

The duct 10 in general is formed essentially perpendicular to the central axis 5, its function being to receive a cooling fluid enabling regulation of the temperature of the molding device 1 at this point, by absorbing the heat energy from the preform 3, which has been heated beforehand in order to make it easier to shape.

The duct 10 in the bottom 6, particularly when this duct is produced in the form of at least one groove, has a rear part, which is therefore the part closest to the molding cavity 7, it being possible for the position of this rear part along the central axis 5 to generally follow the shape of the molding cavity 7 in order to maximize the exchange of heat.

The duct in the form of at least one groove naturally has walls between the successive groove segments, these walls being in the form of ribs that complement the grooving, and the cover 20 fits against the end of at least part of these ribs so as to thus contribute to the hermetic closure of the duct 10.

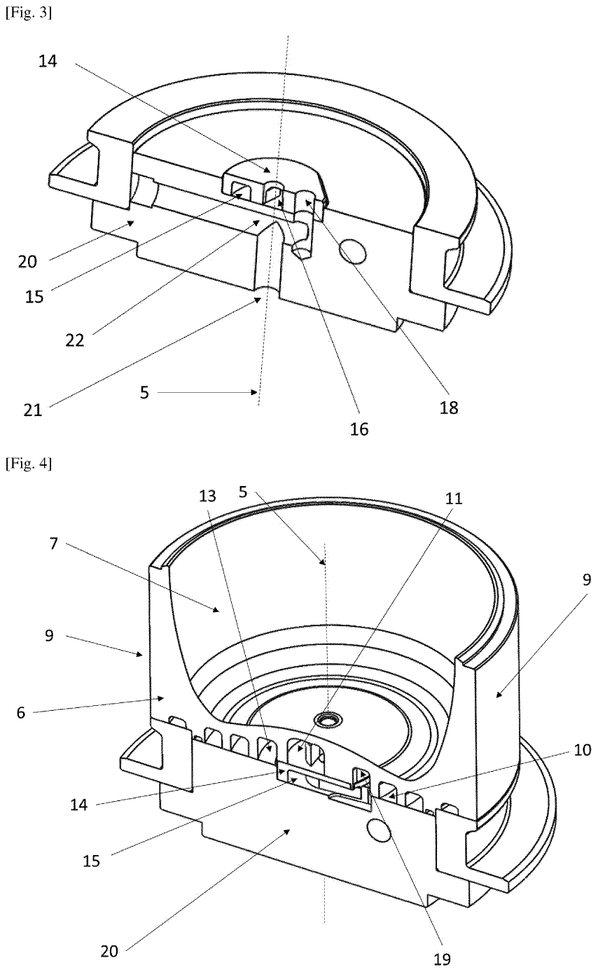

The cover 20 makes it possible, amongst other things, to convey the fluid which is intended next to cool the bottom 6, and therefore convey the fluid in the duct 10 that the bottom 6 exhibits. It also possibly allows the fluid to be discharged after it has circulated in the duct 10. The cover 20 receives the cooling fluid from an element, not depicted, that is situated beyond the cover 20 in the bottom 6 then cover 20 sequence of stacking along the central axis 5. A movement of the cooling liquid that is to be sent into the duct 10 of the bottom 6 is thus created within the cover 20. To this end, the cover 20 has a path 22 in which to circulate the cooling liquid toward the bottom 6, and this path 22 is situated near the central part of the molding device 1, which is to say that the path 22 remains less than 5 centimeters away from the central axis 5, preferably less than 3 centimeters away. This in particular makes it possible to ensure that the liquid entering the bottom 6 does so close to the center, namely close to the central axis 5, with possibly only a small offset therefrom as described later on, so as to provide more intensive cooling of the generally central part of the bottom 6, rather than the part close to the periphery 9, which is what would happen if the fluid arrived in the bottom 6 near to the periphery 9. FIG. 3 shows the path 22 within the cover 20, with a part aligned along the central axis 5. This embodiment also illustrates the potential for the path 22 to have a dogleg, with a segment perpendicular to the central axis 5 followed by a segment that is once more parallel to the central axis 5 but offset from this axis. In practice, such a dogleg is obtained by drilling in from one edge of the device, therefore from the periphery 9, to meet that part of the path 22 that is aligned with the central axis 5, and then beyond, in order to form said dogleg. It will be appreciated that the part of the drilling that lies on the other side of the central axis 5 from the dogleg is not used for circulating fluid toward the bottom 6, but forms a dead-end with regard to the conveying of the fluid, and therefore does not form part of the path 22. In general, those parts of drillings that are used for creating said path 22 but in which the fluid cannot circulate because they form a dead-end, do not form part of the path 22.

In the embodiment illustrated here, the molding device 1 also comprises a distributor 14. This distributor 14 is mounted so that it is sandwiched between the bottom 6 on one side and the cover 20 on the other. As will now be explained, this distributor 14 contributes to conveying the fluid from the path 22 in the cover 22 into the duct 10 in the bottom 6, and to conveying the fluid between various successive portions of said duct 10.

The distributor 14 has the general form of a disk or pellet, and is positioned at the central axis 5 between the bottom 6 and the cover 20. It, on the one hand, allows the incoming liquid to be conveyed into the duct 10 and, on the other hand, enables two successive portions of the duct 10 to be connected to one another.

More specifically, as shown notably in FIG. 3, in one possible embodiment, the distributor 14 has an axial orifice 18 which extends parallel to the central axis 5 but some distance therefrom. This axial orifice 18 faces the outlet opening 22, hollowed in the cover 20 for the circulation of the liquid toward the duct 10. This axial orifice 18 is therefore likewise close to the central axis 5, less than around 3 centimeters away, and contributes to bringing the incoming liquid as close as possible to the molding cavity 7 thanks to flow that is essentially parallel to the central axis 5. This axial orifice 18 allows the cooling liquid to pass through the distributor 14 in the direction of the central axis 5 so that the cooling liquid begins its cooling action close to the central axis 5 but slightly offset therefrom, namely closer to the central axis 5 than to the periphery 9.

The distributor 14 also comprises a passage 15 for circulating the liquid, more particularly from an inlet opening 16 of said passage 15, which opening is situated at the central axis 5, as far as an outlet opening 17 of said passage 15, which opening is distant from the central axis 5, see FIG. 6. This passage 15 enables two successive portions of the duct 10 to be placed in fluidic communication, as will be described later on. The inlet opening 16 communicates with the downstream end of a first portion 11 of the duct 10, being simply situated facing it, and the outlet opening 17 communicates with the upstream end of a second portion 13 of the duct 10, once again by simply facing it.

The fluid is therefore circulated as follows.

The fluid is initially received by the cover 20 at the central axis 5, more specifically at a passage hole that the path 22 hollowed in it exhibits, see FIG. 3. This path 22, that allows the fluid to circulate within the cover 20 toward the bottom 6, extends less than 3 centimeters away from the central axis 5, thereby making it possible to increase the cooling effect at part of a central disk. Specifically, this path 22 opens out from the cover 20 slightly away from the central axis 5. The fluid thus circulates along this path 22 and leaves the cover 20 without being moved away from the central axis 5 by more than 3 centimeters, or at least by no more than 5 centimeters. The fluid then continues in the axial orifice 18 that the distributor 14 exhibits, said orifice lying in the continuation of the downstream end of the path 22, parallel to the central axis 5. The fluid initially received in the cover 20 in a region close to the central axis 5 therefore progresses along the central axis 5 passing first of all along the path 22 hollowed in said cover 20 and then through the axial orifice 18, all of the time being closer to, but not coincident with, the central axis 5 than to the periphery 9.

The axial orifice 18 of the distributor 14 is slightly offset from the central axis 5 so as to bring the fluid in the duct 10 to a ring that this duct makes around the central axis 5.

Thus, having passed through the axial orifice 18, the fluid continues into a first portion 11 of the duct 10, in order to begin its function of cooling the molding cavity 7. The duct 10, which extends generally perpendicular to the central axis 5, therefore has an entry point for the incoming fluid that is slightly offset from the central axis 5. This entry point forms a first inlet region 12 for a first portion 11 of the duct 10, see FIG. 5. Once it has been conveyed by the cover 20 and then the distributor 14, the fluid therefore arrives in the cooling duct 10 such that it is slightly distant from the central axis 5. The fluid therefore then circulates perpendicular to the central axis 5 in the first portion 11, which begins some distance from the central axis 5 and ends closer to the central axis 5, preferably at the central axis 5. As may be seen in FIG. 5, the first portion 11 extends over at least 180 degrees, and preferably comprises an arc of a circle which extends over at least half a revolution, or even over at least three-quarters of a revolution. This arc of a circle may be followed by a radial linear part to bring the fluid to the central axis 5. It is of course possible to conceive of a more sophisticated shape for the first portion 11, such as, for example, a spiral shape, or else several arcs of a circle the radii of each of which differ, the arcs being connected by radial parts, etc. It may be noted that the first portion 11 is such that the fluid circulates therein from a region that is eccentric with respect to the central axis 5 and progressively moves closer to said central axis 5. It is possible to conceive of the end of the first portion 11 lying at the central axis 5, as in FIG. 5, in which case the first portion 11 extends over all or part of a disk centered on the central axis 5; it is also possible to conceive of the end of the first portion 11 likewise being distant from the central axis 5, although closer thereto than the first inlet region 12 is, in which case the first portion 11 extends over all or part of a ring centered on the central axis 5. The first portion 11 extends preferably over 360 degrees and, at minimum, extends over three-quarters of a revolution or else at least half a revolution, preferably before moving closer toward the central axis 5. This makes it possible to organize for the most powerful cooling, which is to say the first part of the cooling, to be in a hoop progressively concentric about the central axis 5.

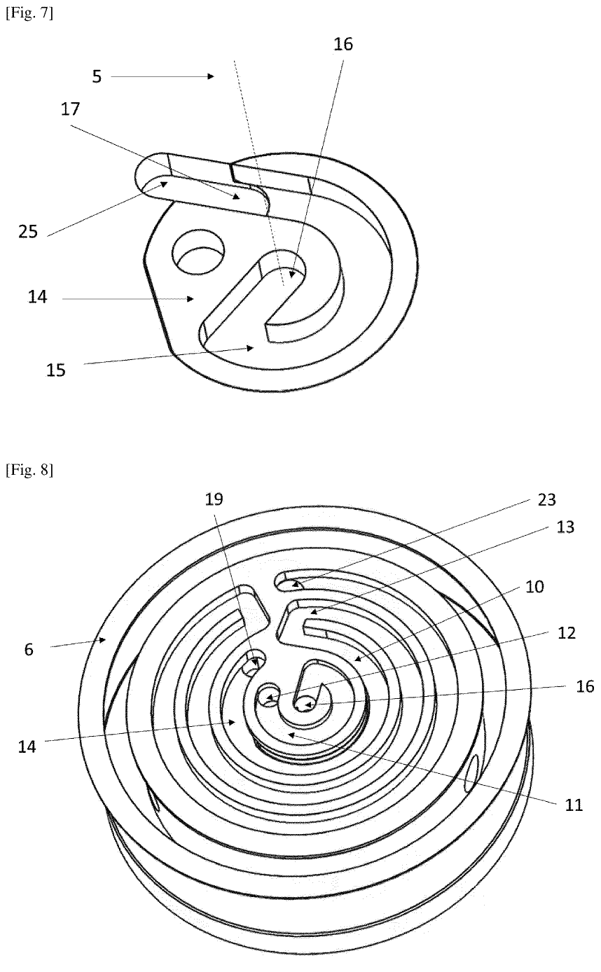

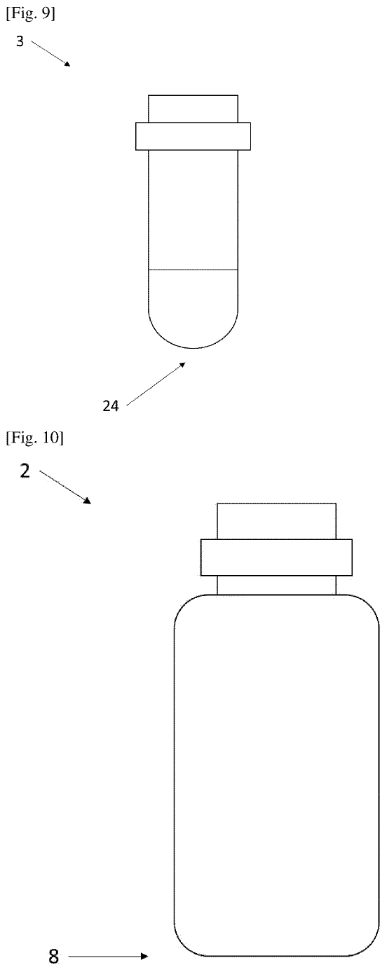

In the embodiment illustrated in FIGS. 5 and 6, once the fluid has finished circulating about the central axis 5, converging toward same, in the first portion 11, it will be redirected further away from the central axis 5 than the first inlet region 12. The fluid then circulates in the distributor 14, within the passage 15 that begins at the central axis 5 with the inlet opening 16, moves away from the molding cavity 7 via a hole along the central axis 5, and then continues in a divergent part visible in FIG. 6. This divergent part begins with a radial portion, followed by a portion in the form of an arc of a circle, followed by a portion that opens onto the external surface of the distributor 14, for example the lateral surface. The passage 15, which facilitates the circulation of the fluid within the distributor 14, therefore contains a part that runs perpendicular to the central axis 5, enabling the fluid to be moved away from the central axis 5, and which is situated further from the molding cavity 7 than that part of the first portion 11 that brings the fluid closer to the central axis 5. These two parts are situated at the central axis 5 but are offset from one another along this axis. The passage 15 therefore comprises a canal that diverges from the central axis 5 and lies some distance from the molding cavity, whereas the duct comprises a canal that converges toward the central axis 5 and lies closer to the molding cavity, these two canals lying in different planes perpendicular to the central axis 5 so that the convergent one is closer to the molding cavity 7 than the divergent one. Having entered the distributor 14 at an inlet opening 16 facing the outlet of the first portion 11, at the central axis 5, the fluid thus leaves the distributor 14 at an outlet opening 17 facing the inlet of the second portion 13 of the duct 10, namely at a second inlet region 19 situated some distance from the central axis 5, see FIG. 7. FIGS. 5 and 6 reveal that the second inlet region 19 is slightly further away from the central axis 5 than the first inlet region 12.

More specifically, as may be discerned from FIGS. 4 and 7, the outlet of the passage 15 is generally perpendicular to the central axis 5. A cavity 25 is hollowed into the cover 20 to receive the fluid leaving the passage 15 and send it back to the second inlet region 19. This cavity 25 therefore creates a fluidic connection between the passage 15 in the distributor 14 and the second inlet region 19, and the fluid therein circulates generally parallel to the central axis 5. Specifically, because the outlet of the passage 15 is in a plane that is slightly further away from the molding cavity 7 than is the duct 10, the cavity 25 in the cover allows it to run up parallel to the central axis 5 as far as the duct 10, at the second inlet region 19.

As mentioned above, the fluid in the first portion 11 of the duct 10 circulates such that it converges toward the central axis 5; in the second portion 13, the fluid circulates such that it diverges away from the central axis 5, from the second inlet region 19.

The second portion 13 therefore comprises parts in the form of an arc of a circle and radial parts for connecting these. The fluid then meanders, in a region generally perpendicular to the central axis 5, such that it moves further away from the central axis 5, given the profile of the duct 10. The fluid thus circulates as far as its position furthest from the central axis 5 where it meets a discharge canal 23 made in the cover 20 and which extends parallel to the central axis 5 so as once again to keep the fluid away from the region in which the cooling is organized, by circulating it along the central axis 5. It will thus be appreciated that, in general, the cooling is organized in a region that extends perpendicular to the central axis 5, that the fluid arrives in this region by following a path close to the central axis 5 and is then moved slightly away from the central axis 5 to begin its cooling in the duct 10 from a region distant from the central axis 5 and in a direction heading toward same, and then, by being circulated in a parallel level, further away from the molding cavity 7, is once again sent further away from the central axis 5 as before, but this time in order to continue cooling from this distant region but such that it moves further away from the central axis 5. What is produced is therefore a first cooling, in a ring around the central axis 5, possibly a ring that makes a full revolution or the majority of a full revolution about the central axis 5, and then a cooling of a part comprised to the inside of this ring, and then a part to the outside of this ring. Of course, a plurality of such sequences may be conceived of: a plurality of convergent cooling passes and/or a plurality of divergent cooling passes.

The invention thus implements a method that may be described as follows.

The cooling of the molding device 1 is achieved by conveying the cooling liquid, generally water or glycol, into a serpentine duct 10 formed, which is to say hollowed, a short distance from the molding cavity 7 against which the previously-heated preform 3 is going to lie. Cooling is therefore achieved by circulating the liquid close to the molding cavity 2 and, before that, the fluid is brought close to the molding cavity by circulating along the central axis 5, close to same. Thus, in the cooling sequence, the fluid begins by cooling the base-piece 4 at a distance slightly distant from the central axis 5, circulates around the central axis 5 and then moves closer to said axis until it potentially reaches same. After this first cooling step, which is performed by virtue of the first portion 11 of the duct 10, the cooling fluid continues its cooling from a region which is almost as distant from the central axis 5 as was the region where cooling began, and in a direction toward the periphery 9, therefore the outer contour, of the molding device 1. The duct 10 allows a cooling which is therefore organized on each side of a circle centered on the central axis 5. In a first phase, by circulating in the first portion 11 formed to the inside of this circle, the fluid cools to the inside of this circle, beginning with a part that forms at least a large proportion of the periphery of this circle, and then continuing on toward the central axis 5. The fluid then, by next circulating in the second portion 13, cools to the outside of this circle, beginning close to said circle and progressively moving away therefrom toward the periphery. This circle, which therefore delineates the first period of cooling, to its inside, from the second period of cooling, to its outside, lies between the central axis 5 and the periphery 9. By circulating first of all along the circumference of the circle over at least half or even three-quarters of a revolution before heading toward the central axis 5, the cooling therefore begins with a ring or hoop some distance from the central axis 5, before continuing on toward the inside as far as the central axis 5. In the part to the inside of the circle, the fluid does not have any movement directed from the center toward the outside, thereby ensuring that that region of the molding cavity 7 that lies at the periphery of this circle is indeed the region that undergoes the greatest cooling.

In particular, in instances in which the molding cavity 7 has a petaloid shape, thus having hollows of generally radial extension distributed along the circumference, around a central part from which these hollows extend, the circle that delimits the first portion 11 to its inside and the second portion 13 to its outside is situated close to the transition zone representing the transition between the central part and the hollows for the petaloid bottom. This circle, and therefore the first-cooling ring defined by the circumference thereof, is therefore such that the hollows of the petaloid formation lie for the most part outside of the circle. What is therefore cooled first of all is a ring beyond which the ends of the hollows that will subsequently form the seating base of a petaloid bottom lie. The cooling of the petaloid part comes after the cooling of the central part, which itself comes after the cooling of a full or almost-full loop. Cooling is therefore performed in a hoop shape, and then in a manner that converges and then in a manner that diverges from said hoop.

During the blow-molding of the preform 3, the vertex 24 is stretched at least a direction perpendicular to the central axis 5, because both the diameter and the length of the preform 3 are significantly smaller than those of the container 2. The base 8 of the container 2 therefore has a central region that is amorphous, with very little stretching, followed radially by an oriented peripheral region which, by contrast, has experienced a far greater amount of stretching.

Advantageously, the circle, which to its inside delimits the first portion 11 and to its outside delimits the second portion 13, lies at the transition between the amorphous central region and the oriented peripheral region of the base 8 of the container 2 subsequently obtained. The molding cavity 7 is therefore cooled first of all at the end of the amorphous central region and at the start of the oriented peripheral region, rather than at the central axis 5 or at the periphery 9.

Thus, advantageously, the first portion 11 may extend to the inside of a circle the radius of which equates to between one third and half of the distance, from the central axis 5, of the lowermost point of the molding cavity 7, which therefore contributes to forming the seating base of the container 2, at its base 8. The arc of the first portion 11 therefore possibly lies, with respect to the central axis 5, at a distance that equates to between one third and half of the distance, from the central axis 5, of the deepest points of the molding cavity 7, these points subsequently forming the seating base of the container 2.

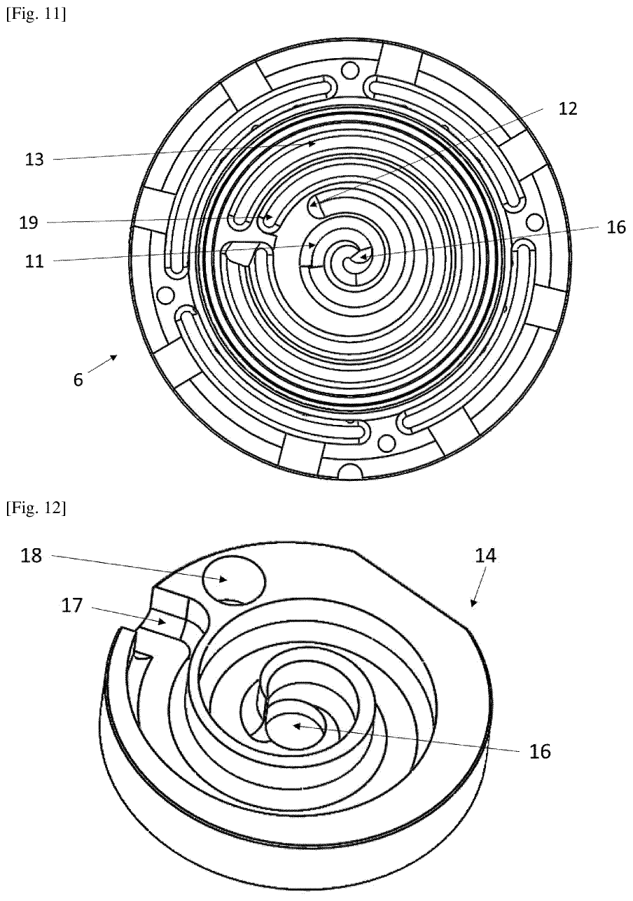

FIGS. 11 and 12 show profiles of spiral type. FIG. 11 thus shows a bottom 6 in which the first portion 11 of the duct 10 has a spiral shape. Said first portion 11 therefore begins at the first inlet region 12 which is distant from the central axis 5, as has already been explained, and then moves progressively closer to the central axis 5. Here, the arc of the first portion 11 thus also moves progressively closer to the central axis 5. In other words, in general, the arc of the first portion 11 may likewise cause the fluid to move closer to the central axis 5 as it circulates around said central axis 5. As this figure shows, the downstream end of the first portion 11, and therefore the inlet opening 16, once again lies at the central axis 5. In general, the first portion 11, from its upstream end, and therefore from the inlet region 12, revolves around and some distance away from the central axis 5 over at least half a revolution or even over three-quarters of a revolution or even more than one revolution in the case of a spiral, before arriving at said central axis 5 at its downstream end, and therefore at the inlet opening 16.

FIG. 12 shows a distributor 14 of which the passage 15 has a spiral shape, through which the liquid travels in a divergent direction. By analogy, the fluid circulates in a convergent manner in the spiral-shaped first portion 11 of FIG. 11.

FIG. 12 shows the arrangement, with a spiral configuration, of the outlet opening 17 at the periphery of the distributor 14, of the inlet opening 16 at the central axis 5, and of the axial orifice 18 offset from the central axis. The spiral-shaped configuration of the passage 15 allows the cooling liquid or fluid to circulate continuously from the inlet opening 16 to the outlet opening 17 while avoiding any flow disturbances that would otherwise be brought about by right angles.

As a preference, the directions of flow of the fluid flowing essentially in a convergent manner in the first portion 11 and essentially in a divergent manner in the passage 15 are the opposite of one another, this being regardless of whether the profiles are curved and continuous as in the case of spirals, or somewhat discontinuous as in the case with right angles. More specifically, the first portion 11 may cause the fluid to move closer to the central axis 5 as it circulates around this axis in the clockwise direction, whereas the passage 15 may cause the fluid to move further away from the central axis 5 as it circulates about this axis in the clockwise direction. It is preferable for the directions of, on the one hand, the pathway close to the molding cavity 7, in the first portion 11 and, on the other hand, the pathway on a level further from the molding cavity 7, where the passage 15 is situated, to be the opposite of one another because that allows for better distribution of the cooling effort.

Although the invention has been described with reference to preferred embodiments, it is conceivable for all or some of the features thereof which have been identified here to be combined with one another.

1. A device for molding a container from a preform, the device comprising a base piece and having a central axis, said base piece having a bottom centered on the central axis, wherein the bottom comprises a molding cavity against which the preform can be pressed so as to create a container base,
wherein the bottom further comprises an external periphery and a duct, wherein the duct extends generally transversely to the central axis between the central axis and the external periphery, wherein the duct is configured to circulate fluid for controlling a temperature of the device,
wherein the duct comprises:
a first portion having a first inlet region offset from the central axis to receive the fluid, and
an arc distant from the central axis.
wherein the duct is configured to circulate the fluid from the first inlet region along the arc a distance away from the central axis then returning the fluid nearer to the central axis.

2. The device as claimed in claim 1, wherein the duct further comprises a second portion located between the first portion and the external periphery, the second portion located downstream of the first portion so that the fluid flows first in the first portion and then in the second portion.

3. The device as claimed in claim 2, wherein the base piece comprises a distributor arranged against the bottom at the central axis, wherein the distributor comprises a passage for the fluid, the passage comprising an inlet opening configured to receive the fluid leaving the first portion and further comprising an outlet opening configured to supply the fluid to the second portion.

4. The device as claimed in claim 3, wherein the distributor has an axial orifice extending at least partially along the central axis and offset therefrom, the axial orifice opening into the first inlet region to convey the fluid into the first portion.

5. The device as claimed in claim 2, wherein
the second portion comprises a second inlet region where it receives the fluid and causes the fluid to flow away from the central axis toward the external periphery.

6. The device as claimed in claim 5, wherein the base piece comprises a cover comprising a path for conveying the fluid toward the duct, wherein the path is configured to move the fluid at least partly in the direction of the central axis from an inlet point, and wherein the duct comprises a groove hollowed into the base piece and is closed by the cover.

7. The device as claimed in claim 1, wherein the molding device further comprises lateral shells that extend along the central axis and against which the preform can be pressed so as to create the sides of the container during the blow-molding.

8. A method for manufacturing a plastic container by blow-molding a preform, the method comprising:
placing the preform in a molding device, the molding device having a central axis and comprising a basepiece having a bottom;
injecting a pressurized gas into the preform to cause it to conform to the interior contour of the molding device until a container is formed;
controlling the temperature of the molding device using a fluid, wherein
the controlling is achieved by circulating the fluid in the molding device at the base-piece, wherein the circulation is along a path generally transverse to the central axis beginning in a first phase in a ring around the central axis at a distance from both the central axis and an exterior surface of the base-piece, the fluid then heading toward or away from the central axis.

9. The method as claimed in claim 8, further comprising placing the preform in the molding device such a vertex of the preform lies at the level of the central axis after stretch-blow-molding.

10. The method as claimed in claim 8, wherein the fluid circulates toward the central axis after a first phase of circulating the fluid in the base-piece.

11. The method as claimed in claim 10, wherein the circulating of the fluid in the basepiece comprises a phase subsequent to the first phase and during which the fluid circulates away from the central axis from beyond the ring.
